(19) United States
(12) Patent Application Publication
(10) Pub. No.: US 2018/0005175 A1
(43) Pub. Date: Jan. 4, 2018

(54) SYSTEMS AND METHODS OF MANAGING INVENTORY USING AN RFID KANBAN SYSTEM

(71) Applicant: Richard PHILIPPE, Laval (CA)

(72) Inventor: Richard PHILIPPE, Laval (CA)

(21) Appl. No.: 15/543,426

(22) PCT Filed: Jan. 13, 2016
(86) PCT No.: PCT/CA2016/050028

§ 371 Date: Jul. 13, 2017

Related U.S. Application Data
(60) Provisional application No. 62/102,737, filed on Jan. 13, 2015.

(51) Int. Cl. G06Q 10/08; G06K 7/10; B65F 1/14

(52) U.S. Cl. CPC G06Q 10/087; B65F 1/1463; G06K 7/10366

(57) ABSTRACT

A system for provisioning products. The system includes a set of bins for each product, wherein at least one bin of each set of bins is affixed with a corresponding Radio Frequency Identification (RFID) tag. The system also includes at least one replenishment zone for receiving bins, at least one detection unit for reading an RFID tag of a bin placed in the at least one replenishment zone and generating provisioning requests, a least one processing unit for processing the provisioning requests and issuing instructions responsive to the provisioning requests, at least one communication unit for communicating the provisioning requests, and a memory for storing the provisioning requests.

### FIELD

The present disclosure mates to the field of tracking inventory. More particularly, the present disclosure relates to improved Kanban replenishment systems and methods that include radio frequency identification (RFID) tags.

### Introduction

Health care, industrial, and distribution facilities are generally organized with multiple departments, with each department storing and using various products. Racks are typically provided to store multiple products in various areas within each department. Such facilities may rely on the principle of “Kanban” for storing products in two bins. This particular replenishment system provides storage for the same product in two bins: a first bin and a second bin. The first and second bins are provided on a rack or a shelf. Products stored in the first bin are consumed first, and when the first bin is empty, the corresponding, empty first bin is removed from its primary location and placed a nearby location designated for empty bins in some cases this may be top of he shelf.

The presence of the first bin in the location designated for empty bins indicates that the first bin is empty and must be replenished. The empty bin is manually identified by staff and then replenished.

In some instances, bins may be affixed with a barcode that may scanned to identify the product stored in the bin. Until the first bin is replenished, products stored in the second bin are consumed. When the second bin becomes empty prior to provisioning of its corresponding first bin, the empty second bin is also removed from the rack and placed in the location designated for empty bins.

Manual intervention to replenish products may delay the turnaround time for replenishing stock if staff does not identify empty bins in a timely manner. Moreover, when products are out of stock (i.e., when both bins are empty) staff must spend time dealing with the stockout issue and find a way to work around this challenge. Back office resources may also be required to perform supply assessments to maintain an optimal balance between having sufficient product available for use and reducing inventor costs of holding and storing valuable inventory.

Canadian Patent Application 2,565,934 describes a Kanban replenishment system that provides distinct removable identification tags for the first and second bins. As shown in FIG. 1, when the first is empty, the corresponding identification tag is removed from the first bin and affixed to a provisioning board located nearby.

The presence of the identification tag of the first bin on the provisioning board indicates that the first bin is empty and must be provisioned. Until the first bin is provisioned products stored in the second bin are used. When the second bin becomes empty prior to provisioning of its corresponding first bin, both corresponding identification tags are affixed to the provisioning board.

The identification tags are Radio Frequency Identification (RFID) tags and the provisioning board is adapted to read the RFID tags so as to automatically generate a provisioning request. This solution alleviates provisioning by automating the generation of provisioning requests. The use of removable RFID tags in this type of Kanban replenishment system has greatly improved provisioning turnaround time and stock management.

However, to ensure proper automatic generation of provisioning requests, it is necessary that the removable RFID tags be put on the provisioning board when the first bin is empty, and furthermore that the removable RFID tags be returned to the correct bin upon receipt of new provisions. Such steps often require a change of existing practices and procedures in various facilities such as health care facilities. Failing to perform such steps hinders the automatic generation of provisioning requests.

### BRIEF DESCRIPTION OF THE DRAWINGS

For a better understanding of the various embodiments described herein and to show more clearly how these various embodiments may be carried into effect, reference will be made, by way of example only to the accompanying drawings which show at least one exemplary embodiment, and in which are now described:

FIG. 1 is a schematic representation of a Kanban replenishment system having removable RFID tags.

FIG. 2 is a flow chart of a method for provisioning products of a Kanban replenishment system having removable RFID tags.

FIG. 3 is a schematic representation of a Kanban replenishment system having RFID tags affixed to bins according to some embodiments.

FIG. 4 is a flow chart of a method for replenishing products of a Kanban replenishment system having RFID tags affixed to bins according to other embodiments.

FIG. 5 is a flow chart of a method for using products of a Kanban replenishment system having RFID tags affixed to bins according to yet another embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures, to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the subject matter described in accordance with the teaching herein,” unless expressly specified otherwise.

The terms “including,” “comprising” and variations thereof mean “including but not limited to”, unless expressly specified otherwise. A listing of items does not imply that any or all of the items are mutually exclusive unless expressly specified otherwise. In addition, the terms “a,” “an” and “the” mean “one or more,” unless expressly specified otherwise.

It should also be noted that the terms “coupled” or “coupling” used herein have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices is an electrical element or electrical signal (either wired or wireless) or a mechanical element depending on the particular context.

Further, although processes, methods, and the like may be described (in the disclosure and/or in the claims) having acts in a certain order, such processes and methods may be configured to work in alternate orders while still having utility. In other words, any sequence or order of actions that may be described does not necessarily indicate a requirement that the acts be performed in that order. The acts of processes and methods described herein may be performed in any order that is practical and has utility. Further, some actions may be performed simultaneously, if possible, while others may be optional, if possible.

When a single device or article is described herein, it may be possible that more than one device/article (whether or not they cooperate) may be used in place of a single device/article. Similarly, where more than one device or article is described herein (whether or not they cooperate), it may be possible that a single device/article may be used in place of the more than one device or article.

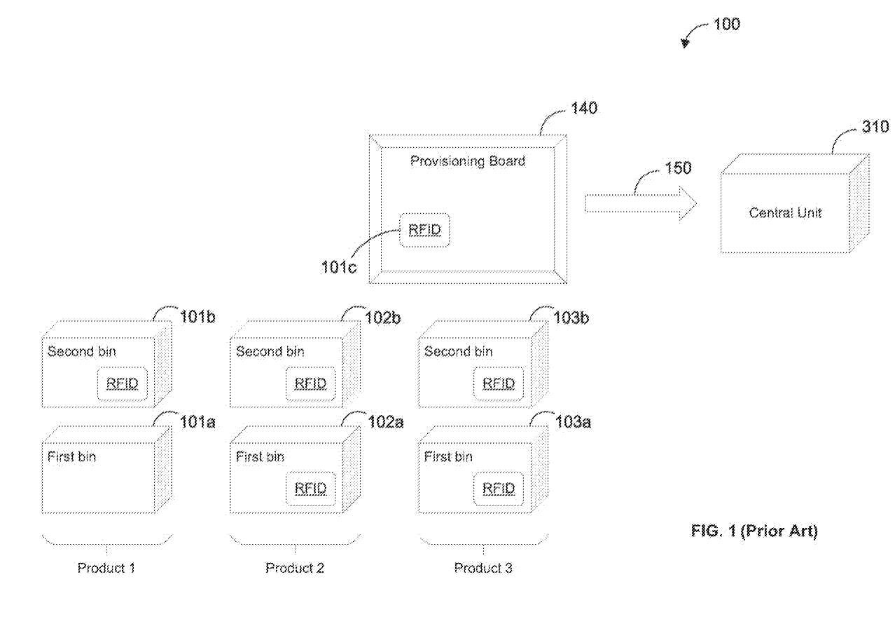

Health care facilities such as hospitals, as well as industrial, retail, and distribution facilities are normally divided in multiple departments, each of which relates to a particular specialization. Each department uses general and specific products, which are typically stored in multiple areas of the department. Storage is often performed using storage equipment that allows the organization of products in two bins, as schematically shown in FIG. 1. This type of organization is often referred to as a Kanban system.

Typically in such a system 100, a rack (not shown for clarity purposes), is used to organize storage bins. For each product (products 1 to 3), a group of bins are assigned, namely a first bin 101a, 102a, 103a and a second bin 101b, 102b, 103b. One particular type of product is thus stored at each location in both the first bin 101a, 102a, 103a and the second bin 101b, 102b, 103b, in some replenishment systems a separate removable radio frequency identification (RFID) tag is associated with each of the first and second bins.

As each first bin 101a, 102a, 103a and each second bin 101b, 102b, 103b store a same product, each RFID tag is unique and corresponds to a particular product in a specific bin (i.e., first or second bin) located at a particular location/department in the facility. When one of the bins becomes empty, the corresponding RFID tag is removed from the bin (as shown for products 1 and 3) and placed on a provisioning board 140.

The provisioning board 140 includes an RFID reader to read the RFID tags, and generate provisioning request 150 therefore to a central processing unit 310. The provisioning request 150 may be sent by various ways, such as wirelessly, over an intranet, via the Internet, and so on.

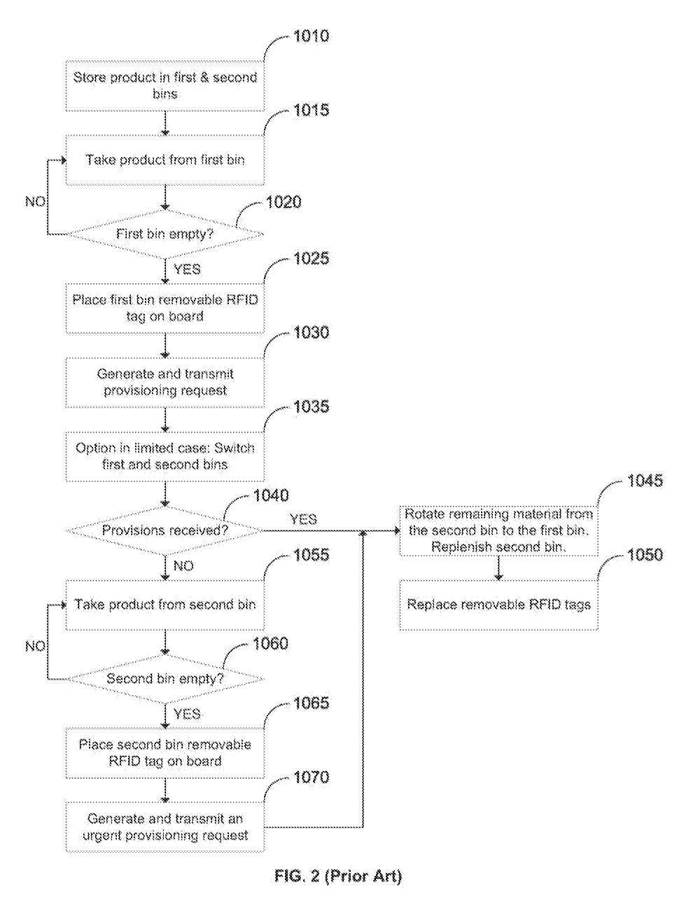

Reference is now currently made to FIG. 2, which represents a flow chart of a method for provisioning products in the Kanban replenishment system having removable RFID tags, such as shown in FIG. 1. The method starts with storing 1010 the product in the corresponding first bin 101a, 102a, 103a and second bin 101b, 102b, 103b. Then, in the course of daily activities, staff take 1015, when needed, the product from the first bin 101a. Staff continue taking 1015 the product from the first bin until the first bin 101a is empty 1020. When the first bin 101a is empty, the staff that takes the last product from the first bin 101a places 1025 the corresponding removable RFID tag 130 on the provisioning board 140. The provisioning board 140 automatically generates and transmits 1030 a provisioning request 150 for that product. Optionally, it is also possible to switch 1035 the first bin 101a and second bin 101b so as to facilitate access to the products in the second bin 101b.

If provisions are received 1040, the method continues with rotating remaining products from the second bin 101b to the first bin 101a, and replenishing 1045 the second bin 101b (and optionally the first bin 101a). Upon completing the rotation and replenishing of the first bin 101a and the second bin 101b, the corresponding removable RFID tag 101c is removed from the provisioning board 140 and replaced 1050 on the corresponding bin.

In the event that provisions are not received for the empty first bin 101a when that corresponding product is required, the product is then taken 1055 from the second bin 101b unfit the second bin 101b becomes empty as well 1060. When the second bin 101b also becomes empty, its removable RFID tag is placed 1065 on the provisioning board 140, and an urgent provisioning 150 is generated and sent 1070.

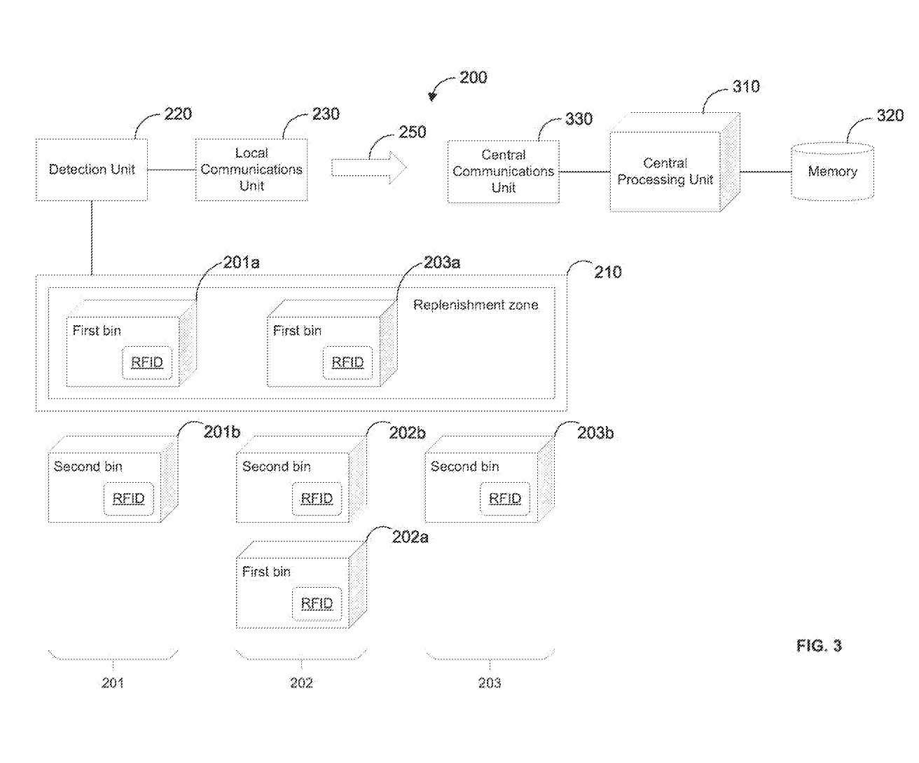

Reference is now made to FIG. 3, which is a schematic representation of at least one embodiment of a system for replenishing products of a Kanban replenishment system 200 wherein at least some of the bins have RFID tags attached thereto. More particularly, the system 200 generally provides sets of bin 201, 202, and 203, each set of bins 201, 202, and 203 being assigned a product. In this example embodiment, each set of bins is comprised of two bins 201a and 201b for set 201; 202a and 202b for set 202; 203a and 203b for set 203. In other embodiments, each set of bins may be comprised of any number of bins. In some embodiments, the number of bins of a first set may be different from the number of bins of a second set.

In this example embodiment, each bin 201a, 201b, 202a, 202b, 203a, and 203b is affixed with an RFID tag. However, in other embodiments, only one bin of each set may be affixed with an RFID tag (not shown). Each RFID tag may correspond to the 201a, 201b, 202a, 202b, 203a, and 203b; the set of bins 201, 232, and 203 the product provisioned by the set of bins 201, 202, and 203; or some combination of the bin set, and product.

The system 200 also provides a replenishment zone 210 adapted to receive empty bins 201a and 203a The replenishment zone 210 is typically in a location nearby the set of bins. The replenishment zone 210 is generally an area that may take various shapes, sizes and appearances. For example, the replenishment zone 210 may be a shelf (such as the top shelf in of a rack), receptacle, table top, or any other means for holding bins. In other example embodiments, the system 200 may provide a plurality of replenishment zones (not shown).

The system 200 generally further provides a detection unit 220 coupled to the replenishment zone 210. The detection unit 220 is generally configured to read RFID tags of bins 201a and 203a within the replenishment zone 210. The detection unit 220 and replenishment zone 210 generally cooperate to ensure that the detection unit 220 only reads RFID tags of bins 201a and 203a within the replenishment zone 210, and in particular does not read the RFID tags of bins 201b, 202a, 202b, and 203b outside of the replenishment zone 210.

In other example embodiments, the system 200 may provide more than one detection unit (not shown) coupled to the replenishment zone 210.

In at least one embodiment, the replenishment zone 210 may be equipped with shielding (not shown) that creates a barrier for radio frequency (RF) signals. When the replenishment zone 210 is equipped with shielding the detection unit 220 may include an antenna that is in a location, typically within the replenishment zone 210 to read RF signals of RFID tags of bins 201a and 203a within the replenishment zone 210. By creating a barrier for RF signals, shielding helps prevent the detection unit 220 from reading RFID tags of bins 201b, 202a, 202b, and 203b outside of the replenishment zone 210.

When the replenishment zone 210 is equipped with shielding, the replenishment zone 210 has less physical space requirements. For example, when the set of bins 201, 202, and 205 are located on a rack with a plurality of shelves including one top shelf, the replenishment zone 210 may be provided by any shelf of the rack because the shielding isolates the replenishment zone 210 from the RF Signals of RFID tags of bins 201b, 202a, 202b, and 203b on all other shelves.

A replenishment zone 210 with less physical space requirements may also offer greater flexibility in positioning the replenishment zone 210 nearby other items having RFID tags and RF signals that may cause or are susceptible to interference, for example, medical equipment or mobile electronic devices.

In at least one embodiment, the replenishment zone 210 may not be equipped with shielding. When the replenishment zone 210 is not equipped with shielding, the detection unit 220 may include a directional antenna, a near range antenna, or a low-power antenna.

When the detection unit 220 is a directional antenna, the detection unit 220 is positioned in a direction towards the replenishment zone 210 and a direction away from the bins 201b, 202a, 202b 203b outside of the replenishment zone 210. For example, when the set of bins 201, 202, and 203 and replenishment zone 210 are located on a rack with a plurality of shelves including one top shelf and one bottom shelf, the replenishment zone 210 may be provided by either the top shelf or the bottom shelf, otherwise the detectionunit 220 may also read RF signals of RFID tags of bins 201b, 202a, 202b, and 203b on other shelves.

When the detection unit 220 is a near range antenna or a low-power antenna, the replenishment zone 210 may include an area that corresponds to the maximum range of the near range antenna or the low-power antenna. In order to ensure that the antenna does not read RFID tags of bins 201b, 202a, 202b, and 203b outside of the replenishment zone 210, the bins 201b, 202a , 202b, and 203b may be located outside of the maximum range of the near range antenna or the low-power antenna.

The detection unit 220 may be configured to periodically read RFID tags of bins placed in the replenishment zone 210. The frequency of this reading, the detection frequency, affects power consumption and may be configured according to the demand of the products provisioned in the sets of bins 201, 202, and 203. For instance, when products have a high demand, a maximum detection frequency may be selected. When products have a lower demand, a lower detection frequency may be selected.

As shown in FIG. 3, the system 200 further comprises a local communication unit 230 coupled to the replenishment zone 210 and the detection unit 220. In some other embodiments, the system 200 may provide a local communication unit 230 coupled to a plurality of detection units (not shown).

The detection unit 220 may be configured to generate a provisioning request 250 that is communicated by a local communication unit 230 to a central communication unit 330. The provisioning request 250 is generally generated from RFID tags of bins 201a and 203a in the replenishment zone 210. The provisioning request 250 may also include a replenishment zone identifier. The replenishment zone identifier may identify the replenishment zone 210 from which the bins 201a and 203 are read from and the provisioning request 250 originates from. The replenishment zone identifier may be determined by the detection unit 220 or the local communication unit 230.

In this example embodiment, the central communication unit 330 is coupled to a central processing unit 310 and memory 320. The local 230 and central 330 communication units may be any wired or wireless means to transmit and receive data between two locations. The central processing unit 310, central communication unit 330, and memory 320 may be located on-site at the facility, or off-site of the facility. The provisioning request 250 may be encrypted by the local communication unit 230 and decrypted by the central communication unit 330, which may be desirable when the central communication unit 330 is located off-site of the facility.

The local communication unit 230 and central communication unit 330 may be configured in a push or pull protocol. When the local 230 and central 330 communication units are configured in a pull protocol, the central communication unit 330 may periodically transmit a request for information from the local communication unit 230. In response, the local communication unit 230 may transmit a provisioning request 250 based on the most recent reading of bins 201a and 203a in the replenishment zone 210. The pull protocol may reduce the likelihood of transmission errors when the central communication unit 330 receives provisioning requests 250 from a plurality of local communication units 320 simultaneously. As well, errors may be identified in the pull protocol if the central communication unit 330 does not receive a response to a request for information from a local communication unit 230. When the local 230 and central 330 communication units are configured in a push protocol, the local communication unit 230 may transmit a provisioning request 250 following each reading of the replenishment zone 210 without waiting for a request for information from the central communication unit 230. The push protocol may result in shorter turnaround time for provisioning products.

In this example embodiment, the central processing unit 310 is a processing unit that controls the overall system 200. The central processing unit 310 may be one or more processors that have enough computing power to provide the various functions of the central processing unit 310. In other embodiments, the system 200 may be controlled by a plurality of processing units (not shown) that need not be located together.

In the example embodiment shown in FIG. 3, the central processing unit 310 is generally configured to process the provisioning request 250 and issue instructions responsive to the provisioning request 250 based on information stored in the memory 320. To process the provisioning request 250, the central processing unit 310 may access the memory 320 and store the provisioning request 250 in the memory 320.

In at least one embodiment, the central processing unit 310 stores the date and time of the provisioning request 250 in the memory 320 as well. Using the date and time of provisioning requests 250, the central processing unit 310 may then determine whether a provisioning request 250 is an initial provisioning request or a subsequent provisioning request and store the provisioning request 250 accordingly. An initial provisioning request generally refers to the first provisioning request 250 for a bin 201a or 203a after the bin 201a or 203a is placed the replenishment zone 210. A subsequent provisioning request generally refers to any provisioning request 250 after the initial provisioning request. Subsequent provisioning requests 250 may occur while the initial provisioning request has not been fulfilled and the detection unit 220 reads bins 201a and 203a in the replenishment zone 210 again.

In at east one embodiment, the memory 320 may store each bin identifier or each set identifier in relation with a product identifier. The product identifier comprises at least one of a predefined Common User Product (CUP) code and a Device Identification Number (DIN), The memory 320 may also store each, bin identifier in relation with a set identifier, The memory 320 may also store each bin identifier or each set identifier with a replenishment zone identifier.

Accessing the memory 320, the central processing unit 310 may determine the product identifier, and if necessary, the replenishment zone identifier, corresponding to each provisioning request 250. In at least one embodiment, the central processing unit 310 may also store the product identifier in the memory 320 with the provisioning request 250.

In at least one embodiment, the replenishment zone identifier may comprise location information about the replenishment zone 210. In other embodiments, the memory 330 may be configured to further store location identifiers for each replenishment zone identifier to provide location information about the replenishment zones 210. Any number of location identifiers may be used as necessary to provide sufficient detail about the location of the replenishment zone 210. For instance, a first location identifier may identify the area within a building that the replenishment zone 210 is located. If the system 200 supports replenishment zones 210 in multiple buildings, a second location identifier may identify the building that the replenishment zone 210 is located. The central processing unit 310 may determine the location identifiers corresponding to the replenishment zone identifiers.

The central processing unit may further issue instructions in response to the provisioning request 250. The instructions generally comprise the replenishment zone identifier, including location identifiers, as well as the product identifier. The instructions may be immediately issued upon receipt of the provisioning request 250. Alternatively, the central processing unit 310 may accumulate provisioning requests 253 and issue instructions. Upon request, at a predefined frequency, or after a predefined quota of provisioning requests 250. Staff may subsequently fulfill the provisioning request 250 by bringing product corresponding to the product identifier to the replenishment zone 210 identified by the replenishment zone identifier, replenishing bin 201a and 203a, and restoring bins 201a and 203a to their normal location outside of the replenishment zone 210.

The central processing unit 310 may also be configured to determine whether the provisioning request 250 is a regular provisioning request or an urgent provisioning request and issue instructions accordingly. In one example, a normal provisioning request generally refers to the provisioning request 250 for a first bin 201a or 203a of a set of bins 201 or 203 placed in the replenishment zone 210 and an urgent provisioning request generally refers to the provisioning request 250 for a second bin 201b or 203d of the same set 201 or 203 placed in the replenishment zone 210. Urgent provisioning requests may occur when the provisioning request 250 for the first bin of a set of bins has not been fulfilled, the product in the second bin is used up, and the second bin is placed in the replenishment zone 210. When an urgent provisioning request is identified, the central processing unit 310 may be configured to issue ad hoc instructions without waiting for the request for instructions, the predefined frequency, or the predefined quota.

In at least one embodiment, the memory 320 may also store information about product availability for provisioning. The product available for provisioning may be available on-site or off-site. The information on product availability for provisioning generally comprises the product identifier and an indication of the product availability.

When the central processing unit 310 has access to memory 320 with information on product a liability for provisioning, the central processing unit 310 may issue instructions accordingly. For instance, if the products corresponding to the bins 201a and 203a in the replenishment zone 210 are not available, the central processing unit 310 may issue instructions to re-order the products.

In another embodiment, each set of bins 201, 202, 203 may comprise more than two bins. For example, a third or “spare” bin (not shown) may be used to fulfilling provisioning requests 250. The “spare” bin containing the product may be delivered and the empty bin may be collected for future provisioning as the “spare” bin. In another example, all three bins of the set of bins may provision products and an urgent provisioning request may occur when a second bin is empty and placed in the replenishment zone 210.

In another embodiment, each set of bins 201, 202, 203 comprise of only a first bin affixed with an RFID tag and at least a second bin without an RFID tag. In this example embodiment, the system (not shown) after a bin in the replenishment zone 210 is replenished, staff must always ensure that they first empty the first bin affixed with an RFID tag. This can be reinforced when the provisioning request 250 is fulfilled by rotating the product from the second bin into the empty first bin (assuming that there are expiration date considerations) and replenishing the second bin.

In another embodiment, a local processing unit (not shown) and a local memory (not shown) may be provided and coupled to the replenishment zone 210. When a local processing unit and a local memory are provided, some of the processing of the provisioning request 250 and the issuing of instructions may be performed by the local processing unit instead of the central processing unit 310. For instance, the local processing unit may track whether an initial provisioning request 250 has been communicated to the central communication unit 330 and that subsequent provisioning requests 250 need not be communicated. The local memory may also store each bin identifier or each set identifier in relation with a product identifier. The local processing unit may then determine the product identifier corresponding to a set or bin identifier. Instead of the provisioning request 250 comprising a bin identifier, a set identifier, or both, the provisioning request 250 may simply comprise the product identifier.

In another embodiment, the detection unit 220 may be configured to detect changes in the replenishment zone 210 and read RFID tags of bins in the replenishment zone 210 accordingly. For example, the detection unit 220 may include a sensor to detect motion or changes to weight. Upon detection of such changes, the detection unit 220 may then read RFID tags of bins in the replenishment zone 210. Such a detection unit 220 configured to detect changes in the replenishment zone 210 may be beneficial if it is desirable to reduce the amount of time that the detection unit 220 is powered on, for instance, because of power consumption or radio frequency interference concerns.

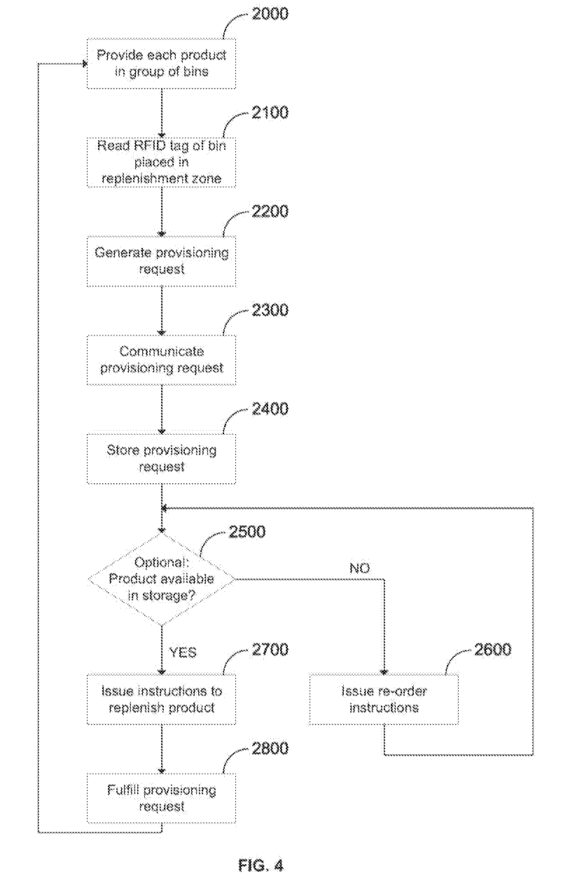

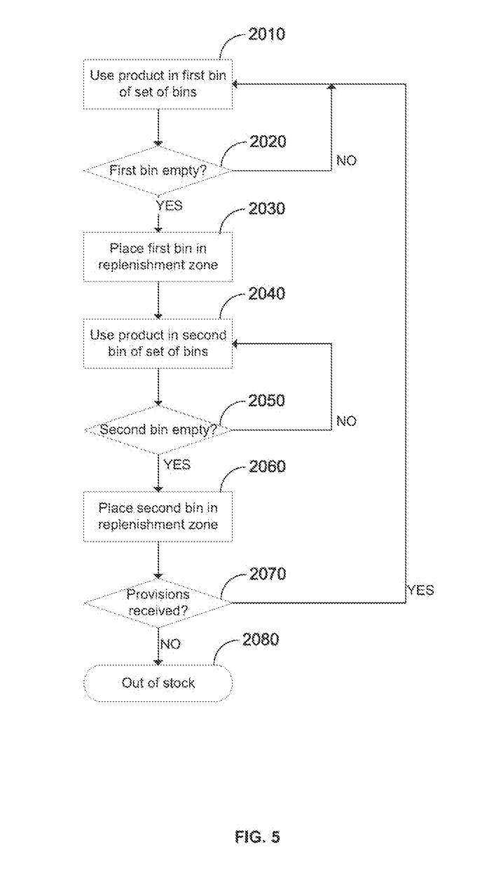

Reference will now be made to FIGS. 4 and 5 concurrently. FIG. 4 shows a flowchart of an example method for replenishing products in a Kanban replenishment system with RFID. FIG. 5 shows a flowchart of an example method of using products in a Kanban replenishment system with RFID. The method begins at act 2000 of FIG. 4 when a set of bins 201 202, and 203 is provided for each product within, for simplicity, a department having one replenishment zone 210. Each set of bins composes at least two bins, for example bins 201a and 201b for set 201: 202a and 202b for set 202: 203a and 203b for set 203. Referring now to FIG. 5, in the course of daily activities, staff use 2010, when needed, the product from the first bin 201a. The staff continue using 2010 the product from the first bin 201a, until the first 201a is empty 2020. When the first bin 201a is empty, the staff that takes the last product from the first bin 201a places 2030 the first bin 201a in the replenishment zone 210.

Referring back to FIG. 4, after the bin 201a is placed in the replenishment zone 210, the detection unit 220 reads 2100 the RFID tag of the bin 201a . As described above, the detection unit 220 may read 2100 the RFID tag of the bin 201a in the replenishment zone 210 periodically. After reading the RFID tag, the detection unit 220 may generate 2200 a provisioning request 250. A local communication unit 230 coupled to the detection unit 220 may communicate 2300 the provisioning request 250 to a central communication unit 330 that is located elsewhere. The central communication unit 330 is coupled to a central processing unit 310 and receives the provisioning request 250. The central processing unit 310 processes the provisioning request 250 by storing 2400 the provisioning request 250 in the memory 320.

When storing 2400 the provisioning request 250, the central processing unit 310 may determine (not shown) whether a provisioning request 250 is an initial provisioning request or a subsequent provisioning request and store the provisioning request 250 accordingly. The central processing unit 310 may also access the memory 320 to determine (not shown) the set identifier, the product identifier, the replenishment zone identifier, or location identifier corresponding to the provisioning request 250.

Optionally, the central processing unit 310 may access the memory to determine 2500 whether product, according to the product identifier, is available for provisioning. If the central processing unit 310 determines 2500 that product is not available for provisioning, the central processing Unit 310 issues 2600 instructions to re-order the product. If the central processing unit 310 determines that product is available for provisioning, the central processing unit 310 issues 2700 instructions to replenish the product. Staff may fulfill 2800 the provisioning request 250 by bringing product to the replenishment zone 210, replenishing the bin 201a, and restoring the replenished bin to its normal location outside of the replenishment zone 210.

Referring back to FIG. 5, until the provisioning request 250 is fulfilled, staff may continue with daily activities and use 2040 product, when needed, from the second bin 201b. When the second bin 201b is empty, the staff that takes the last product from the second bin 201b places 2060 the bin 201b in the replenishment zone 210.

If provisions have not yet been received 2070 for the provisioning request 250 of the bin 201a, the department is out of stock of the product. If the provisioning request 250 of the bin 201e has already been fulfilled, staff may continue with daily activities and use 2010 product, when needed, from the first bin 201a. As can be seen from FIG 5., the staff is not required to change current practices to adopt the system 200. Specifically, the staff is not required to perform additional acts as required in FIG. 2, such as removing RFID tags from corresponding bins.

Since the memory 320 may store product identifiers in relation with set identifiers and the set identifiers in relation with provisioning request identifiers, the memory 320 may be used to locate product within the facility in order to fulfill 2800 the provisioning request. In the event that both the first bin 201a and the second bin 201b are empty and product is not available for provisioning, the central processing unit 310 may access the memory 320 to locate product in another department within the facility based on the unfulfilled provisioning requests 250 stored in memory 320.

In some embodiments, one or more RFID tags may be affixed to one or more pins so as to provide for “retrofitting” of the teachings herein to an existing two-bin inventory management system. For example, in one example, RFID tags may be provided as stickers that are attached to particular bins, and can be used in combination with the systems and methods as described herein. Moreover the replenishment zone and detection unit may be provided as a module that can be affixed to an existing storage location (such as on the top of a shelf or rack). This may allow for existing racks and storage locations to be adapted to use the teachings herein.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way but rather a merely describing the implementation of these various embodiments.

1. A method for provisioning products, wherein that method comprises:
(a) providing a set of bins for each product, wherein at least one bin of each set of bins is affixed with a corresponding Radio Frequency Identification (RFID) tag;
(b) reading an RFID tag of a bin placed in at least one replenishment zone;
(c) generating a provisioning request for the RFID tag read;
(d) communicating the provisioning request;
(e) processing the provisioning request;
(f) issuing instructions responsive to the provisioning request.

2. The method of claim 1, wherein the provisioning request includes at least one of:
bin identifier,
a set identifier, or
a product identifier;
wherein:
the bin identifier identifies the bin placed in the at least one replenishment zone;
the set identifier identifies the set of the bin placed in the least one replenishment zone; and
the product identifier identifies the product provided in the bin placed in the at least one replenishment zone.

3. The method of claim 2 wherein the product identifier comprises at least one of a Common User Product code or a Device Identification Number (DIN).

4. The method of claim 2, wherein the Provisioning request further includes a replenishment zone identifier that corresponds to the at least one replenishment zone in which the bin was placed and read from.

5. The method of claim 1, wherein the act of communicating the provisioning request includes one of a polling protocol and a push protocol.

6. The method of claim 1, wherein the act of communication the provisioning request include one of encrypting and decrypting the provisioning request.

7. The method of claim 1, wherein the act of processing the provisioning request comprises storing the provisioning request in memory.

8. The method of claim 1 wherein the act of processing the provisioning request further comprises:
determining whether the provisioning request is an initial provisioning request or a subsequent provisioning request;
the initial provisioning request being a first provisioning request after a bin is placed in the at least one replenishment zone; and
subsequent requests being any provisioning request after the initial provisioning request and while the bin remains in the at least one replenishment zone.
The method of claim 1, wherein the act of processing the provisioning request further comprises:
determining whether the provisioning request is a normal provisioning request or an urgent provisioning request;
a normal provisioning request being provisioning requests corresponding to a predefined number of bins of a set placed in the at least one replenishment zone end an urgent provisioning request being a provisioning requests corresponding to additional bins of a set placed in the at least one replenishment zone while the predefined number of bins of the set remains in the at least one replenishment zone.

10. The method of claim 2, wherein the act of processing the provisioning request further comprises determining at least one of a set identifier, a product identifier, a replenishment zone identifier, and a location identifier corresponding to the provisioning request; the location identifier identifying the location of the at least one replenishment zone.

11. The method of claim 1, wherein the act of processing the provisioning request further comprises determining whether product corresponding to the provisioning request is available for provisioning.

12. The method of claim 1 wherein the act of issuing instructions responsive to the provisioning request comprises at least one of issuing instructions to replenish the product and issuing instructions to order the product.

13. The method of claim 12, wherein the act of issuing instructions responsive to the provisioning request further comprises identifying another set of bins within the system providing product corresponding to the replenishment request and determining whether the other set of bins within the system has replenishment requests that have not been fulfilled.

14. The method of claim 1, wherein the act of issuing instructions responsive to the provisioning request is performed immediately upon receipt of the provisioning request, at a predefined frequency, or after a predefined quota of provisioning requests have accumulated.

15. A system for provisioning products, comprising:
a set of bins for each product, at least one bin of each set of bins is affixed with a corresponding Radio Frequency Identification (RFID) tag;
at least one replenishment zone for receiving bins;
of least one detection unit for reading an RFID tag of a bin placed in the at least one replenishment zone and generating provisioning requests;
at least one processing unit for processing the provisioning requests and issuing instructions responsive to the provisioning requests;
at least one communication unit for communicating the provisioning requests; and
a memory for storing the provisioning requests.

16. The system of claim 15, wherein the provisioning request includes at least one of:
a bin identifier,
a set identifier, or
a product identifier:
wherein;
the bin identifier identifies the bin placed in the at least one replenishment zone;
the set identifier identifies the set of the bin placed in the at least one replenishment zone; and
the product identifier identifies the product provided in the bin placed in the at least one replenishment zone.

17. The system of claim 16, wherein the product identifier comprises at least one of a Common User Product code or a Device Identification Number (DIN).

18. The system of claim 16, wherein the provisioning request includes a replenishment zone identifier that corresponds to the at least one replenishment zone in which the bin was placed and read from.

19. The system of claim 18, wherein the memory stores each bin identifier in relation with at least one of a set identifier, a product identifier, and a replenishment zone identifier.

20. The system of claim 18, wherein the memory stores each set identifier in relation with at least one of a product identifier and a replenishment zone identifier.

21. The system of claim 16, wherein the memory stores each product identifier in relation with information of its availability for provisioning.

22. The system of claim 18, wherein the memory stores each replenishment zone identifier in relation with a location identifier identifying the location of the at least one replenishment zone.

23. The system of claim 15, wherein the at least one replenishment zone comprises an area not equipped with shielding, the detection unit for reading an RFID tag of a bin placed in the at least one replenishment zone comprises at least one of a directional antenna, a near range antenna and low-power antenna.

24. The system of claim 15, wherein the at least one replenishment zone for receiving bins comprises an area equipped with shielding.

25. The system of claim 15, wherein the at least one detection unit further comprises a sensing unit including at least one of a motion or force detector for detecting a bin placed in the at least one replenishment zone.

26. The system of claim 15, wherein the at least one detection unit periodically reads RFID tags of bins placed in the at least one replenishment zone and the frequency of readings is selectable.
